(19) United States
(12) Patent Application Publication
(10) Pub. No.: US 2009/0287957 A1
(43) Pub. Date: Nov. 19, 2009

(54) METHOD FOR CONTROLLING A MEMORY MODULE AND MEMORY CONTROL UNIT

(76) Inventors: Christoph Bilger, Munich (DE); Peter Gregorius, Munich (DE); Michael Bruennert, Munich (DE); Maurizio Skerlj, Munich (DE); Wolfgang Walthes, Munich (DE); Johannes Stecker, Munich (DE); Hermann Ruckerbauer, Moos (DE); Dirk Scheideler, Munich (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 12/122,300

(22) Filed: May 16, 2008

(51) Int. Cl. G06F 11/20

(52) U.S. Cl. 714/8; 714/E11.087

(57) ABSTRACT

A memory control unit for controlling a memory module comprising a plurality of memory cells, said memory control unit comprising means for detecting failure of at least one memory cell, means for deactivating said at least one defective memory cell, means for assigning the address of said at least one defective memory cell to at least one replacement memory cell, first tracking means for tracking the remaining replacement memory cells and masking means to hide the address of a defective memory cell to prevent further usage of this address instead of assigning said address to a replacement memory cell.

### BACKGROUND OF THE INVENTION

The invention relates to the field of semiconductor memory modules, e.g. DRAM-modules. In particular, the invention relates to a memory control unit and a method for controlling one or more memory modules.

Memory modules are widely used in electronic systems incorporating digital electronics, such as personal computers, music players, digital cameras, networking servers, routers, or the like. Usually, these electronic devices are controlled by a microprocessor. Standard memory operations are performed through a memory control unit either integrated into the microprocessor, integrated into the memory module, or as a stand alone device. Standard memory operations include read and write operation on specified addresses.

The memory module itself contains one or more memory cells, each of which may represent one bit. One or more memory cells may be organized as a memory block. One or more memory blocks may be organized as a memory bank. One or more memory banks may be organized as the memory module.

The failure of a single memory cell may result in the failure of a full memory block, a full memory bank or even a full memory module. This may result in the failure of the electronic device comprising the memory module. Therefore, memory modules are exchanged in regular intervals as a measure of preventive maintenance on electronic devices which comprise or handle sensitive or important data.

### SUMMARY OF THE INVENTION

One embodiment of the invention relates to a memory control unit for controlling a memory module comprising a plurality of memory cells, said memory control unit comprising a means for detecting failure of at least one memory cell, a means for deactivating said at least one defective memory cell, a means for assigning the address of said at least one defective memory cell to at least one replacement memory cell, a first tracking means for tracking the remaining replacement memory cells, and a masking means to hide the address of a defective memory cell to prevent further usage of this address.

Another embodiment of the invention relates to a memory control unit for controlling a memory module comprising a plurality of memory cells, said memory control unit comprising a means for detecting failure of at least one memory cell, a means for deactivation of said at least one defective memory cell, a means for assigning the address of said at least one defective memory cell to at least one replacement memory cell, a first tracking means for tracking the remaining replacement memory cells, a masking means to hide the address of a defective memory cell to prevent further usage of this address, wherein said masking means can be deactivated until the number of said replacement memory cells has reached a predefined number, and a second tracking means to track the remaining memory cells.

Another embodiment of the invention relates to a method for controlling a memory module comprising a plurality of memory cells, said method generally comprising detecting failure of at least one memory cell, deactivating said at least one defective memory cell, assigning the address of said at least one defective memory cell to at least one replacement memory cell or alternatively hiding the address of a defective memory cell to prevent further usage of this address instead of assigning said address to a replacement memory cell, and tracking the remaining replacement memory cells.

Yet another embodiment of the invention relates a method for controlling a memory module comprising a plurality of memory cells, said method generally comprising detecting the failure of at least one memory cell, deactivating said at least one defective memory cell, assigning the address of said at least one defective memory cell to at least one replacement memory cell, tracking the number of remaining replacement memory cells by use of first tracking means, hiding the address of a defective memory cell to prevent further usage of this address instead of assigning said address to a replacement memory cell if said number of said replacement memory cells has reached a predefined number and tracking the remaining memory cells by use of second tracking means.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1a illustrates an example of a system architecture and an example of assignment of tasks and functions, according to an embodiment of the invention.

FIG. 1b illustrates an example of a schematic diagram of a memory control unit according to an embodiment of the invention

FIG. 2 illustrates an example of evolution of memory content over time, according to an embodiment of the invention.

FIG. 3 illustrates an example of the effect of customer specific thresholds on the memory replacement interval, according to an embodiment of the invention.

FIG. 4 illustrates another example of the effect of customer specific thresholds on the memory replacement interval, according to an embodiment of the invention.

### DETAILED DESCRIPTION OF THE PREFERRED EMBODIMENT

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Also, signal names used below are examples of names, indicative of signals used to perform various functions in a given memory device. In some cases, the relative signals may vary from device to device. Furthermore, the circuits and devices described below and depicted in the figures are merely examples of embodiments of the invention. As recognized by those of ordinary skill in the art, embodiments of the invention may be utilized with any memory device.

Embodiments of the invention may generally be used with any type of memory. In one embodiment, the memory may be a circuit included on a device with other types of circuits. For example, the memory may be integrated into a processor device, memory controller device, or other type of integrated circuit device. Devices into which the memory is integrated may include system-on-a-chip (SOC) devices. In another embodiment, the memory may be provided as a memory device which is used with a separate memory controller device or processor device.

In both situations, where the memory is integrated into a device with other circuits and where the memory is provided as a separate device, the memory may be used as part of a larger computer system. The computer system may include a motherboard, central processor, memory controller, the memory, a hard drive, graphics processor, peripherals, and any other devices which may be found in a computer system. The computer system may be part of a personal computer, a server computer, or a smaller system such as an embedded system, personal digital assistant (PDA), or mobile phone. In some cases, a device including the memory may be packaged together with other devices. Such packages may include any other types of devices, including other devices with the same type of memory, other devices with different types of memory, and/or other devices including processors and/or memory controllers. Also, in some cases, the memory may be included in a device mounted on a memory module. The memory module may include other devices including memories, a buffer chip device, and/or a controller chip device. The memory module may also be included in a larger system such as the systems described above.

In some cases, embodiments of the invention may be used with multiple types of memory or with a memory which is included on a device with multiple other types of memory. The memory types may include volatile memory and non-volatile memory. Volatile memories may include static random access memory (SRAM), pseudo-static random access memory (PSRAM), and dynamic random access memory (DRAM). DRAM types may include single data rate (SDR) DRAM, double data rate (DDR) DRAM, low power (LP) DDR DRAM, and any other types of DRAM. Nonvolatile memory types may include magnetic RAM (MRAM), flash memory, resistive RAM (RRAM), ferroelectric RAM (FeRAM), phase-change RAM (PRAM), electrically erasable programmable read-only memory (EEPROM), laser programmable fuses, electrically programmable fuses (e-fuses), and any other types of nonvolatile memory.

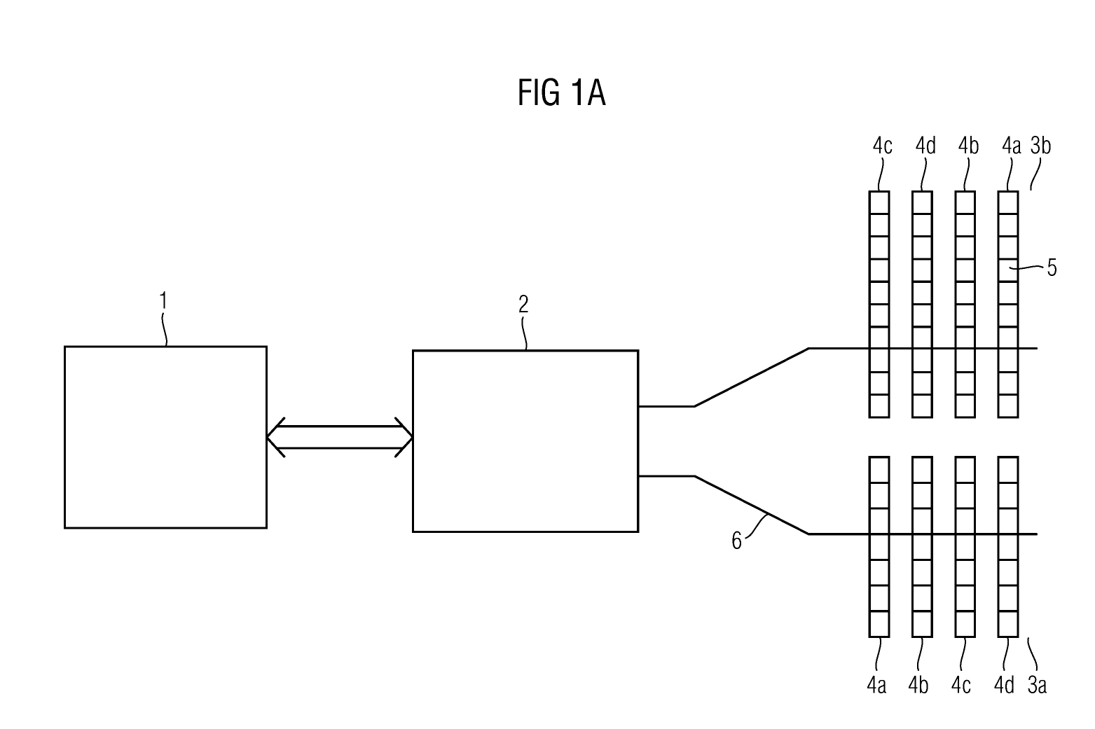

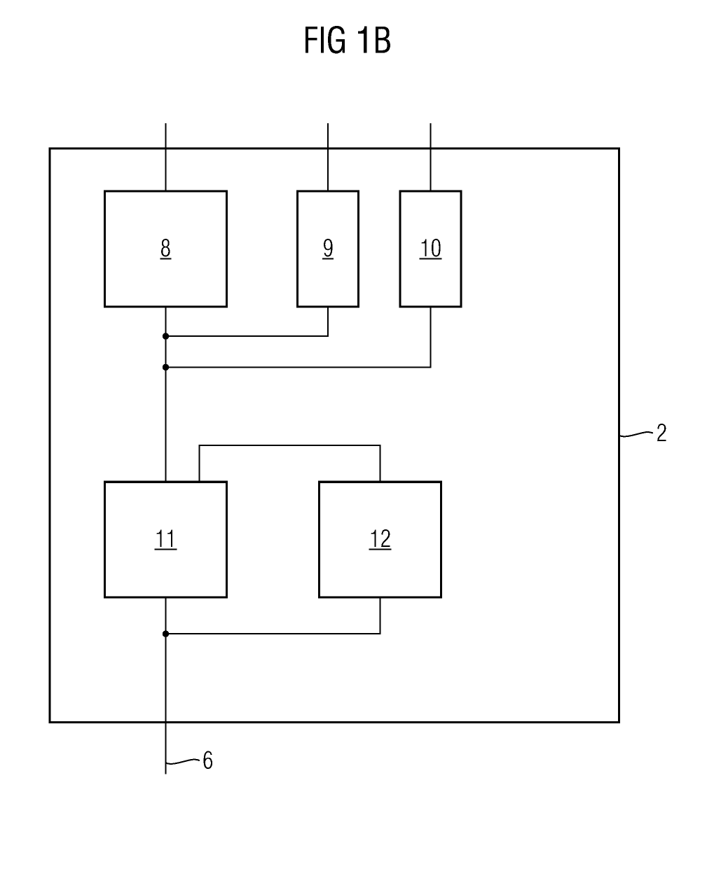

FIG. 1a illustrates an example of a system architecture and an example of assignment of tasks and functions, according to an embodiment of the invention. The system architecture of the device may include a central processor unit 1. This central processor unit may be configured to perform the basic functions of the device, such as compressing and decompressing data, performing calculations, searching or sorting data, displaying information on a screen and the like. While performing these basic functions, data is read and written to memory cells by basic memory operations. In one embodiment, execution of the basic memory operations may be handled by the memory control unit 2. The memory control unit may execute the commands via address and data busses 6 on at least one memory bank 3a and 3b. The result of these commands is handed back via address busses 6 to the memory control unit 2. Then, the result may be passed by memory control unit 2 to the central processor unit 1. Address and data busses 6 may include one or more conductors to allow serial or parallel transport of data. A first subset of the one or more conductors may be dedicated to an address bus, second subset may be dedicated to a data bus, and a third subset may be dedicated to a command bus. In one embodiment, a subset of the one or more conductors may be dedicated to two or more types of busses. For example, the a subset of the conductors may be configured to transmit address and data signals. More than one address bus, command bus and/or data bus may be provided in some embodiments.

The memory control unit 2 may execute commands by accessing at least one memory bank 3. Based on the amount of memory used and the complexity of the memory subsystem, a plurality of memory banks 3a, 3b can be used. FIG. 1 shows only two memory banks as an example. However, the total number of memory banks is not limited to this number.

Each memory bank 3 may include at least one memory block 4. Depending on the complexity of the memory subsystem and the amount of memory used the number of memory blocks can be higher than one. As an example FIG. 1 shows four memory blocks 4a, 4b, 4c and 4d. However, the number of memory blocks provided in each memory bank is not limited to four.

Each memory block may include one or more memory cells. Each memory cell represents at least one bit. As an example one memory block 4 may comprise eight memory cells 5. In other words, in this example, each memory block represents one byte. However, depending on the needs of the electronic device a memory block 4 may include more than eight memory cells 5, e.g. 16, 32 or 64 memory cells.

In one embodiment, the memory blocks 3 may include memory blocks or memory cells which are initially not used for standard memory operations. Accordingly, an address may not be initially assigned to such memory cells. Instead these memory cells may be used to replace defective memory cells and are referred to hereinafter as spare memory cells or replacement memory cells.

FIG. 1b illustrates a more detailed view of the memory control unit 2, according to an embodiment of the invention. Referring to FIG. 1b the memory control unit 2 may include a means 12 for detecting failure of at least one memory cell. Means 12 may be connected to address and data bus 6, and may be configured to observe the data delivered from the respective memory bank, memory block or memory cell when read or write commands are processed by control unit 8. Control unit 8 receives and executes standard memory operations requested by central processor unit 1.

In one embodiment the means 12 for detecting failure of at least one memory cell may also be configured to write and read test data to/from memory cells under test.

If at least one defective memory cell is detected by means 12, a means 11 for reassigning or masking defective addresses is activated. The means 11 may be configured to assign the address of the defective memory cell to one of the spare memory cells provided on the respective memory bank or memory block. Tracking means 9 may be provided to count the number of replacement memory cells left in the respective memory bank. This number may be reported to central processor unit 1 if a respective request from processor unit 1 is made to memory control unit 2.

After new addresses originating from primary, non-working memory cells have been assigned to all replacement memory cells, assigning and masking means 11 may hide an address in the event detecting means 12 detects an error at a memory cell associated with this address. As a result, the total memory capacity of the memory subsystem may decrease. In one embodiment, no data is written to a defective memory and therefore the data is not lost. The decrease in total available memory may be tracked by tracking means 10. Tracking means 10 may report to processor unit 1 the number of total available memory when processor unit 1 sends a corresponding request to memory control unit 2.

Although address and data bus 6 is indicated as a single line in FIG. 1b the invention is not limited to a single address and data bus. On the contrary there may be distinct address, command and data busses. Each of these busses may consist a plurality of conductors to allow performing respective read and write operations. Accordingly, interfaces of standard memory control unit 8, tracking means 9 and tracking means 10 and processor unit 1 may be configured to receive signals from each of the plurality of conductors. Also, the interconnecting lines between standard memory control 8, tracking means 9 and 10, masking means 11 and detecting means 12 may include a plurality of conductive lines.

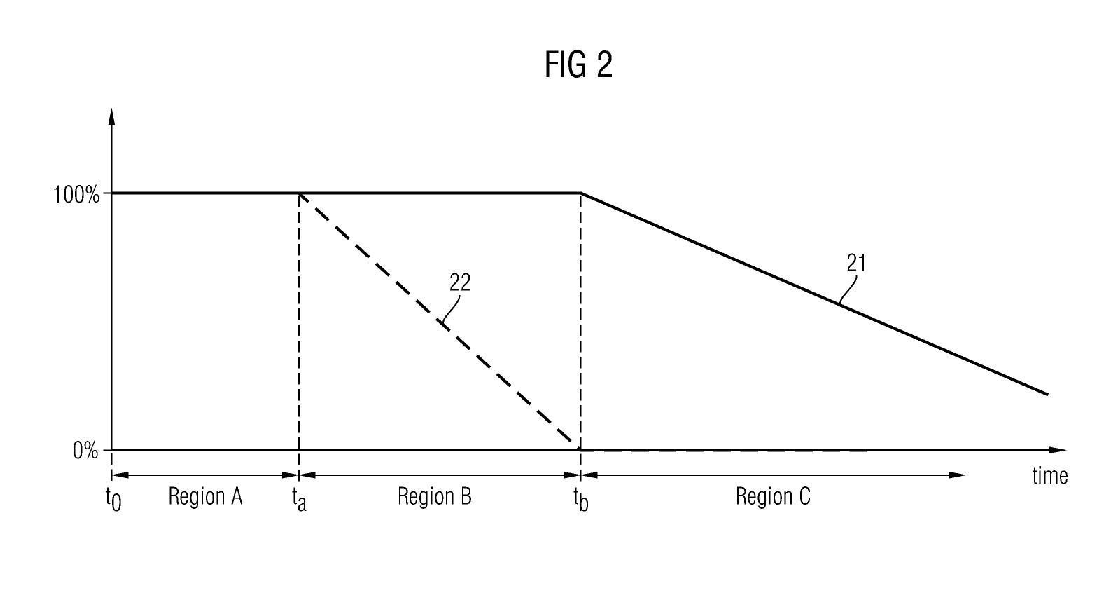

FIG. 2 illustrates the remaining percentage of original memory density, i.e. the number of useable memory cells on the vertical axis and the time of use of the memory module on the horizontal axis. The solid line 21 represents the remaining percentage of useable memory cells and the dashed line 22 represents the remaining percentage of replacement memory cells.

At the point in time t₀ the condition of a newly fabricated memory is shown. All of the original memory cells may be in working condition and therefore, no replacement memory cells may have been activated at t₀. This condition lasts until the first memory cell is defective. This point in time is indicated as tₐ in FIG. 2. The time between tₐ and tₒ is named region A which is referred to herein as the no-fail region.

After point in time tₐ the region B begins and lasts until point in time t_{b}. Region B is referred to herein as the region of redundancy activation. During the time between tₐ and t_{b}, addresses of defective primary memory cells may be assigned to replacement memory cells. As a result the memory control unit can still store data under all the available addresses. During the time between tₐ and t_{b}, the percentage of remaning redundancy cells decreases with every defective memory cell that is encountered. However, the remaining percentage of original memory density remains constant until point in time t_{b}.

At point in time t_{b} region C begins. This region is referred to herein as block masking. After time t_{b}, no defective memory cell can be replaced by a working replacement memory cell as there aren't any replacement memory cells left. As a result, the remaining percentage of original memory density decreases. Region C lasts until the remaining memory is too small for the intended application or the memory module is replaced. The latest possible point in time to replace the memory module is reached when no remaining memory density is left.

It has to be noted that the remaining percentage of original redundancy as well as the remaining percentage of original memory density may not decrease linearly. Both values may decrease in any manner, e. g. steady or unsteady and at different rates.

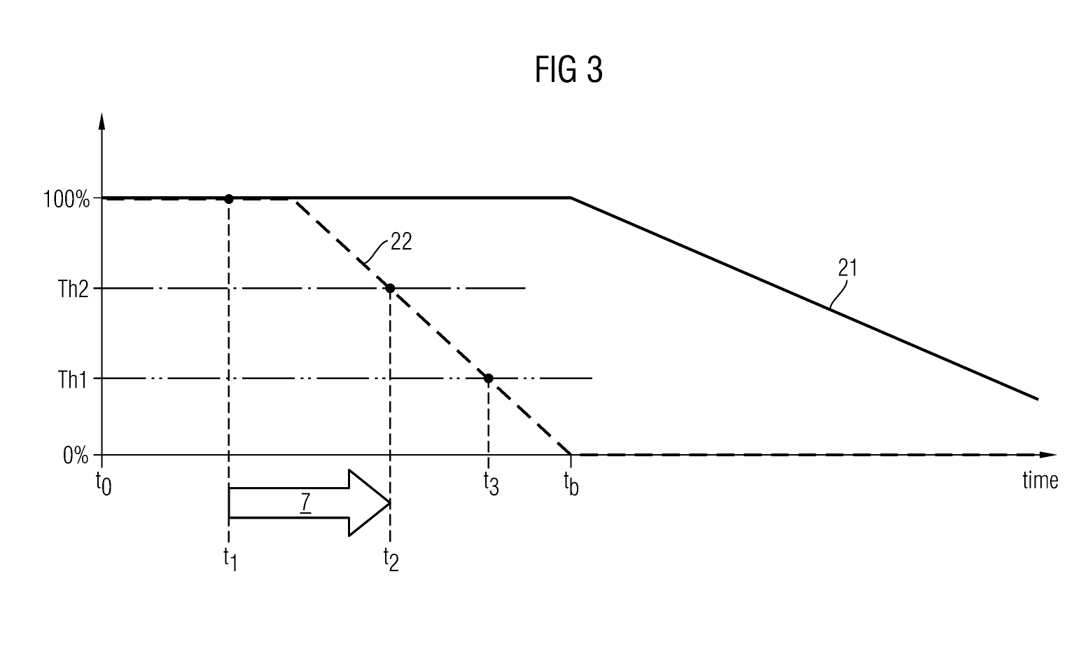

FIG. 3 illustrates an example of service thresholds TH1 and TH2 and their effect on service time of the electronic device comprising the memory control unit and the memory module, according to an embodiment of the invention. In the example according to FIG. 3 the electronic device including the memory control unit according to an embodiment the invention may be an electronic device holding sensitive data, e.g. a bank server. Such an electronic device may include the full memory density and a certain redundancy left to avoid data loss under any circumstances. A memory according to an embodiment of the invention may be inserted into the device at point in time t₀.

The user of a conventional device would perform a preventive maintenance at point in time t₁. T₁ may be chosen from data of existing systems to be a time where a remaining percentage of original redundancy is greater than 0%. In one embodiment, the point in time t₁ may occur when memory cells of the device are not significantly affected by defects. For example, t₁ may occur relatively soon after time t₀ and before time t_{b}. However, in a worst case scenario, as indicated in FIG. 3, time t₁ may occur before tₐ. In this case no replacement memory cell has been used so far and a memory module in perfect condition is replaced.

According to one embodiment of the invention the remaining percentage of original redundancy is tracked by first tracking means 9. The result of this tracking is requested from time to time by central processor unit 1 and indicated to service personnel or a user of the electronic device either directly on a screen or indirectly by writing the values obtained in a log file for off-line analysis. After the remaining percentage of original redundancy has reached a threshold TH2, i.e. a predefined number of replacement memory cells has been assigned addresses of defective memory cells, the replacement of the memory subsystem during next scheduled service may be recommended to the user at a time t₂. In a worst case scenario, this scheduled service may be on the same or the next day. In this case the minimum gain of usage time is indicated by arrow 7. In a best case scenario, the scheduled service may have been completed on or before the day which is indicated by point in time t₂. Therefore, the old memory is used for a further full service period. The gain of usage time is increased further.

After the replacement of the memory subsystem during next scheduled service has been recommended, the remaining percentage of original redundancy is tracked further by first tracking means 9. In case a dramatic decrease in useable memory cells occurs and the remaining percentage of original redundancy drops very fast, the tracking means 9 detects a drop below threshold TH1. In this case, the replacement of the memory module is recommended to service personnel or the user immediately at point in time t₃.

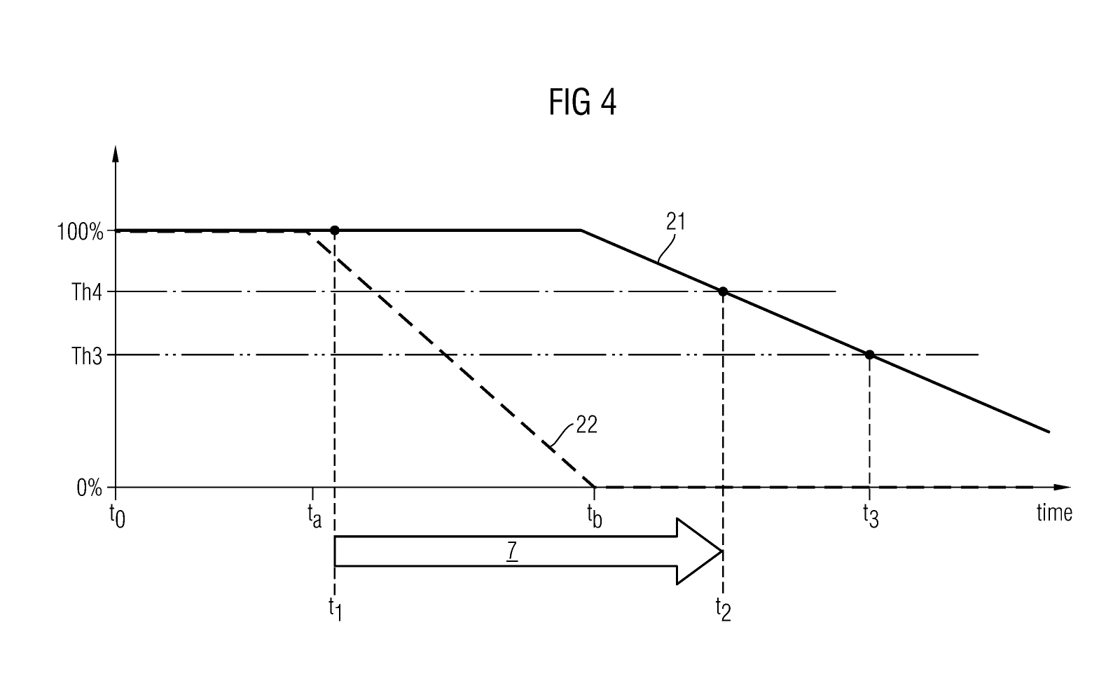

FIG. 4 illustrates another example for service thresholds TH1 and TH2 and their influence on service time of the electronic device comprising the memory control unit and the memory module according to an embodiment of the invention. In the example according to FIG. 4, the electronic device comprising the memory control unit may be an electronic device holding less sensitive data. The user may set a high value on minimum cost of ownership at reasonable risk of data loss. The application may allow a memory subsystem with zero redundancy. Also a reduced amount of total available memory is allowed. The user of a conventional device would replace their memory at point in time t₁ which is shortly after tₐ. At this time conventional error correcting codes would encounter unrecoverable errors.

According to an embodiment of the invention the memory control unit may enter the region A which is the region of redundancy activation and may replace defective memory cells with replacement memory cells by reassigning the addresses of defective cells to working replacement cells. This may be performed by assigning and masking means 11 inside the memory control unit 2. The assigning of addresses of defective memory cells to replacement cells may be continued until point in time t_{b}. This point in time may be determined by first tracking means 9. Addresses of defective memory cells detected after t_{b} are masked by assigning and masking unit 11 and therefore excluded from further usage. Due to this measure the remaining percentage of original memory density may drop.

The remaining percentage of original memory density may be tracked by second tracking means 10. The status of tracking means 10 may be requested from time to time by central processor unit 1. Central processor unit 1 may compare the received value with a user-defined threshold TH4. If the remaining percentage of original memory density is below TH4 the user is informed to replace the memory during next service at point in time t₂. Arrow 7 therefore indicates the minimum gain of usage time due to the memory control unit according to an embodiment of the invention.

During the remaining cycle time up to the next scheduled service the remaining percentage of original memory density is continuously tracked by tracking unit 10. If the remaining percentage drops below threshold TH3 the user of the device may get an additional warning at point in time t₃ to exchange the memory within a shorter time limit, e.g. within one week or one day. The thresholds TH3 and TH4 may be defined according to the security needed and the total cost of ownership spent. As an example TH4 may be chosen between 70 and 80 percent and TH3 may be chosen between 40 and 60 percent.

The embodiments detailed in FIGS. 3 and 4 are only examples for possible maintenance thresholds. In a further embodiment, tracking means 9 may track the remaining replacement memory cells and second tracking means 10 may track the remaining percentage of original memory density depending on usage time. Depending on the measured characteristics, a prediction is made for the remaining usage time, e.g. based on fuzzy logic.

Although several embodiments of the invention have been illustrated in the accompanying drawings and described in the foregoing detailed description, it should be understood that the invention is not limited to the embodiments disclosed, but is capable of numerous rearrangements, modifications and substitutions without departing from the scope of the invention. Some parts of the invention such as the memory control unit 2, the address reassigning and masking unit 11, the error detection unit 12, or the tracking means 9 and 10 may be realized by hardware or software without departing from the scope of the invention.

What we claim is:

1. A memory control unit for controlling a memory module, said memory module comprising a plurality of memory cells, said memory control unit comprising:
a means for detecting failure of at least one memory cell;
a means for deactivation of said at least one defective memory cell;
a means for assigning an address of said at least one defective memory cell to at least one replacement memory cell;
a first tracking means for tracking remaining replacement memory cells that have not been assigned addresses of defective memory cells; and
a masking means to hide addresses of defective memory cells to prevent further usage of the addresses of the defective memory cells.

2. The memory control unit of claim 1, wherein said masking means is deactivated until a number of replacement memory cells available to replace defective memory cells has reached a predefined number.

3. The memory control unit of claim 1, wherein said masking means is deactivated until the last of said replacement memory cells has been assigned an address of a defective memory cell.

4. The memory control unit of claim 1, further comprising a second tracking means for tracking a number of memory cells without defects.

5. The memory control unit of claim 1, further comprising an indicator means for indicating an output of said first tracking means.

6. The memory control unit of claim 5, wherein said indicator means is configured to indicate a point in time to replace said memory module.

7. The memory control unit of claim 1, wherein said masking means is configured to hide a plurality of addresses of a plurality of defective memory cells.

8. A memory control unit for controlling a memory module comprising a plurality of memory cells, said memory control unit comprising:
a means for detecting failure of at least one memory cell;
a means for deactivation of said at least one defective memory cell;
a means for assigning an address of said at least one defective memory cell to at least one replacement memory cell;
a first tracking means for tracking remaining replacement memory cells that have not been assigned addresses of defective memory cells;
a second tracking means for tracking memory cells without defects; and
a masking means to hide addresses of defective memory cells to prevent further usage of the addresses of defective memory cells, wherein said masking means is deactivated until a number of said replacement memory cells that have not been assigned addresses of defective memory cells has reached a predefined number.

9. The memory control unit of claim 8, further comprising an indicator means for indicating an output of said first and second tracking means.

10. The memory control unit of claim 8, wherein said predefined number of replacement memory cells is zero.

11. The memory control unit of claim 8, wherein said indicator means is configured to indicate a point in time to change said memory module.

12. A method for controlling a memory module comprising a plurality of memory cells, said method comprising:
detecting the failure of at least one first memory cell;
deactivating said at least one defective first memory cell;
assigning an address of said at least one defective first memory cell to at least one replacement memory cell;
tracking a number of replacement memory cells that have not been assigned addresses of defective memory cells; and
hiding the address of a second defective memory cell to prevent further usage of the address of the second defective memory cell.

13. The method of claim 12, wherein the address of second defective memory cell is hidden to prevent further usage of the address upon determining that the number of said replacement memory cells that have not been assigned addresses of defective memory cells has reached a predefined number.

14. The method of claim 12, wherein the address of the second defective memory cell is hidden to prevent further usage of the address upon determining that the last of said replacement memory cells has been assigned.

15. The method of claim 12, wherein a number of memory cells without defects is tracked by use of second tracking means.

16. The method of claim 12, further comprising indicating a point in time to replace said memory module.

17. The method of claim 16, wherein the point in time to replace said memory module is determined by extrapolating the number of memory cells without defects at the time of replacement of said memory module from the data tracked by said first and second tracking means.

18. A method for controlling a memory module comprising a plurality of memory cells, said method comprising:
detecting the failure of at least one first memory cell;
deactivating said at least one defective first memory cell;
assigning an address of said at least one defective first memory cell to at least one replacement memory cell;
tracking a number of replacement memory cells that have not been assigned an address of a defective memory cell by use of a first tracking means;
hiding an address of a defective second memory cell to prevent further usage of the address of the second memory cell if said number of said replacement memory cells that have not been assigned an address of a defective memory cell has reached a predefined number; and
tracking a number of memory cells without defects by use of second tracking means.

19. The method of claim 18, further comprising indicating an output of said first and second tracking means.

20. The method of claim 18, further comprising indicating a point in time to replace said memory module.

21. The method of claim 19, further comprising indicating said number of memory cells without defects and said number of replacement memory cells that have not been assigned an address of a defective memory cell on request.

22. The method of claim 20, wherein said point in time to replace said memory module is indicated if said number of replacement memory cells that have not been assigned an address of a defective memory cell has reached zero.

23. The method of claim 20, wherein said point in time to replace said memory module is indicated if said number of memory cells without defects has reached a predefined number.

24. The method of claim 20, wherein said point in time to replace said memory module is indicated if said number of memory cells without defects has reached between about 75% and about 85% of the initial value.
